(19) United States
(12) Patent Application Publication
(10) Pub. No.: US 2003/0146629 A1
(43) Pub. Date: Aug. 7, 2003

(54) Overhead storage bin lock

(76) Inventor: John E. Cheever, Huntington Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/068,762

(22) Filed: Feb. 5, 2002

(51) Int. Cl. E05C 1/12

(52) U.S. Cl. 292/167

(57) ABSTRACT

What is disclosed is a latch comprising a housing and a pawl that is held in a normal position relative to the housing and capable of extending from the normal position and away from the latch housing along a travel path to maintain connection between the latch and a strike. This improved latch is a locking mechanism that reacts to deflections and bowing in overhead storage compartment bins found in airplanes to maintain positive engagement between the compartment door and bin. In addition, the latch is compatible with existing strikes used in storage compartment bins, and thus does not require existing strikes to be modified or changed for the latch to preserve engagement between the compartment door and bin.

### FIELD OF THE INVENTION

This invention relates generally to the field of locking mechanisms; more specifically, a door locking mechanism for an aircraft overhead storage bin.

### BACKGROUND OF THE INVENTION

One issue that exists in aircraft manufacture is the development of a locking mechanism that does not lose connection when an overhead storage compartment deflects or bows. To maximize storage capacity, overhead storage compartments are increasingly designed with longer bays to accommodate aircraft passengers' demand for more space to store their carry-on luggage. As a result, fewer vertical supports are used to hold the storage compartments in position, which make the compartments subject to a higher likelihood of deflection and bowing. The bowing in a storage compartment is caused by the weight of the compartment's contents as well as moments of stress during times of turbulence and landing.

### DESCRIPTION OF THE RELATED ART

One attempt of solving this issue has been to provide a strike with an extending arm that is rotatably fixed to the overhead storage compartment bin. The arm of this strike can pivot around its fixed point and be flexible enough to accommodate the deflections and bowing in the storage compartment bins. However, this design has the limitation of requiring a modified latch design to accommodate this flexible strike with a rotatable fixed arm. Thus, to incorporate this strike design in airplanes would require the added expense of changing storage compartment latches as well as strikes.

Therefore, a locking mechanism is needed that reacts to deflections and bowing in overhead storage compartment bins to maintain positive engagement between the compartment door and bin. Preferably, the locking mechanism could function without requiring a change or modification in both the strike and latch of existing locking mechanisms for overhead storage compartments.

### SUMMARY OF THE INVENTION

The present invention provides a locking mechanism designed to maintain connection and overcome forces that disturb connection between the door and bin of an overhead storage compartment found in airplanes. The locking mechanism improves the latch of existing designs to include an extendable pawl that reacts to the deflections and bowing in overhead storage compartment bins to maintain positive engagement between the pawl and a strike on the bin. This improved latch is compatible with existing strikes used in storage compartment bins and thus, utilizing this improved latch does not require that existing strikes be modified or changed.

In one embodiment, the latch comprises a housing, a handle rotatably fixed to the housing, an extendable pawl having an angled tip, and a link that connects the handle to the extendable pawl. The extendable pawl is held in a catched position relative to the housing by a catch that is rotatably fixed to the housing. When the door is closed the catch rotates away from the tip of the pawl, the pawl is free to extend from the catched position and away from the housing to follow the movements of a deflecting and bowing bin.

The latch preferably includes a track cover encased within the housing that provides a surface from which the pawl may travel and extend from the housing to follow the movements of and slide along the travel path of a deflecting and bowing bin.

In a preferred embodiment, an angled tip of the extendable pawl has a notch to receive the catch. While the notch is not mandatory to keep the storage compartment door in a closed position, the notch assists the pawl in maintaining positive engagement with the strike of a deflecting and bowing storage compartment bin.

In a preferred embodiment, the extendable pawl is connected to the handle of the latch by a link with two arms that are rotatably joined at a point, wherein one arm is connected to the pawl and the other arm is connected to the handle. The link with the two arms allows for the handle to remain flush to the front portion of the housing when the pawl retracts from its catched position into the housing. This allows a person to close a storage compartment door by pressing the handle in the down position as the door engages with the bin. Alternatively, the link allows the pawl to force the handle up away from the housing when the pawl retracts from its catched position. This provides a warning to the airplane's occupants that the storage compartment door is not fully engaged with the bin.

The pawl preferably has at least one roller, which advantageously assists the pawl when it extends or retracts from a normal latched or catched position.

Although this latch was designed for use in aircrafts, the practicality of the design allows for the latch to be used in a number of arrangements, such as but not limited to storage compartments found in buildings or naval vessels.

And although this summary of the claimed invention provides an idea of what is covered, the invention will be more readily apparent from the following description and appended claims when taken with the drawings.

### BRIEF DESCRIPTION OF THE DRAWINGS

FIG. 1 shows an expanded view of the internal components of the preferred embodiment of the overhead storage bin lock of the invention.

FIG. 1A shows an expanded view of the components linking the catch with the track cover.

FIG. 1B shows an expanded view of the free-travel link connecting the handle with the pawl.

FIG. 2 is an isometric view of the preferred embodiment without the back portion of the housing showing the extendable pawl held in a catched position with respect to the latch housing.

FIG. 2A is a cross section of the embodiment in FIG. 2, along line 2-2.

FIG. 3 is another view of the embodiment in FIG. 2A showing the strike in contact with the pawl causing the pawl to retract into the housing and forcing the handle outward to an unflush position relative to the face of the housing.

FIG. 4 is another view of the embodiment in FIGS. 2A and 3 showing the compartment door in a closed position with respect to the compartment bin where the extendable pawl is engaged with the strike.

FIG. 5 is an isometric view of the embodiment in FIGS. 2A-4 showing the compartment bin in an undeflected normal position.

FIG. 6 is another view of the embodiment in FIG. 5 showing the compartment bin in a deflected position with the spring-loaded pawl extended to maintain positive engagement with the strike.

FIG. 7 is a side profile view of the embodiment in FIGS. 2A-4 showing the spring-loaded pawl extended from its normal position to maintain positive engagement with the strike of a deflecting and bowing compartment bin.

### DETAILED DESCRIPTION OF THE PREFERRED EMBODIMENT

The overhead storage bin lock is designed to compensate for the deflection and bowing in an overhead storage bin to maintain positive engagement. As one may recognize, the overhead storage bin lock could be used to maintain connection with any two objects that could move in opposing directions and is not necessarily limited to overhead storage compartments found on airplanes.

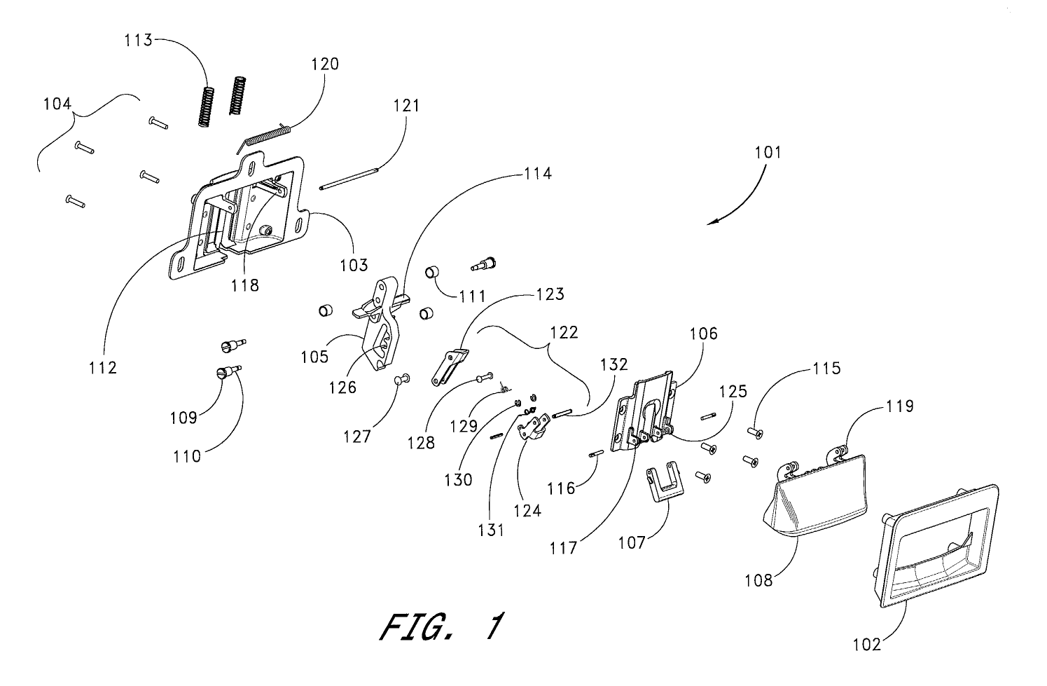

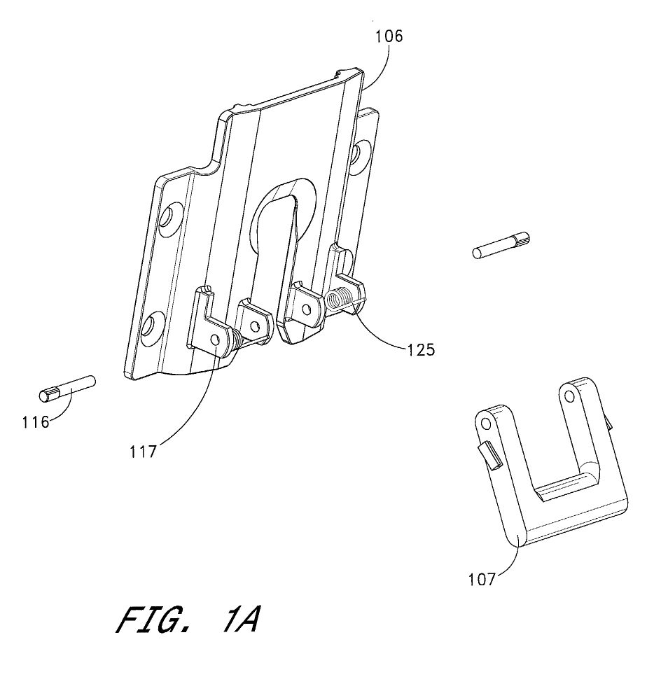

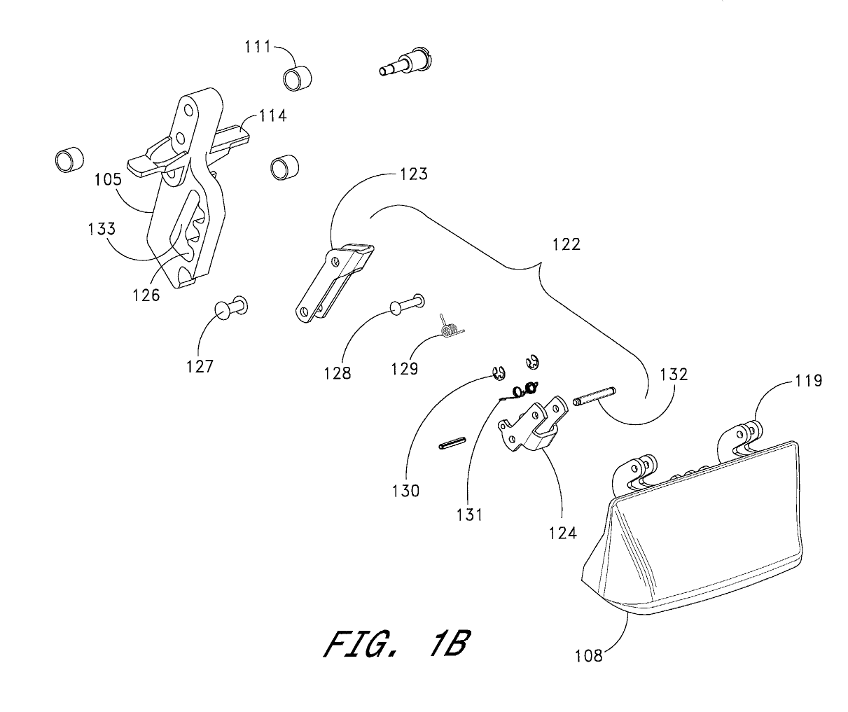

FIG. 1 illustrates the preferred embodiment of the latch 101, which includes a housing having a front portion 102 and a back portion 103, which are connected together by a plurality of housing screws 104. Encased within the housing are an extendable pawl 105, a track cover 106, a catch 107, and a handle 108.

Associated with the extendable pawl 105 are three rollers 109, each mounted on a pin 110 that can be fed through a hole in the pawl and fastened by a nut 111. The rollers 109 are connected to the extendable pawl 105 in a manner such that they are in contact with a track for the pawl to travel on. The track is a surface formed between two sets Of grooves 112 found on one side of the back portion of the housing 103 and one side of the track cover 106.

The grooves 112 are shaped and sized in a manner to house two compression springs 113. The grooves 112 span the full length of the springs 113 and provide for a travel path for the springs to compress and recoil.

The extendable pawl 105 has two wings 114, which are perpendicular to the length of the pawl 105 as shown in more detail on FIG. 1B. Each wing 114 is designed to engage with one end of a compression spring 113. The wings 114 also provide a platform by which the springs 113 may channel a force to the pawl 105, and assist in creating and maintaining positive engagement between the pawl and a strike found on an overhead storage compartment.

The track cover 106 is fastened to the back portion of the housing 103 by a plurality of track cover screws 115. The fastening of the track cover 106 to the back portion of the housing 103 creates a casing that contains the extendable pawl 105, provides the track by which the rollers 109 may travel, and captures the compression springs 113.

The catch 107 is rotatably fixed to the track cover 106. As shown in greater detail on FIG. 1A, the track cover 106 has four lugs 117 that are perpendicular to and extend from the track cover. The catch 107 has two arms; each sized to fit between two of the lugs 117 and fixed together with pins 116, which also extend through the springs 125. The catch 107 is biased by the springs 125 toward the pawl 105, but is capable of rotating about the pins 116 and away from the pawl.

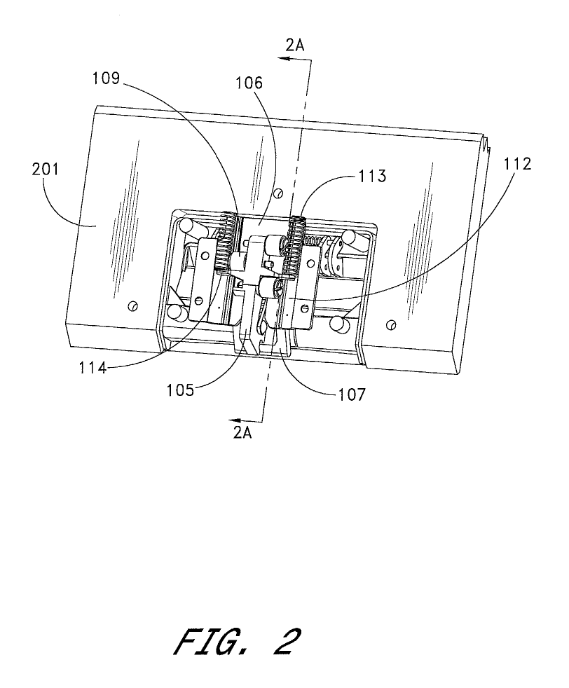

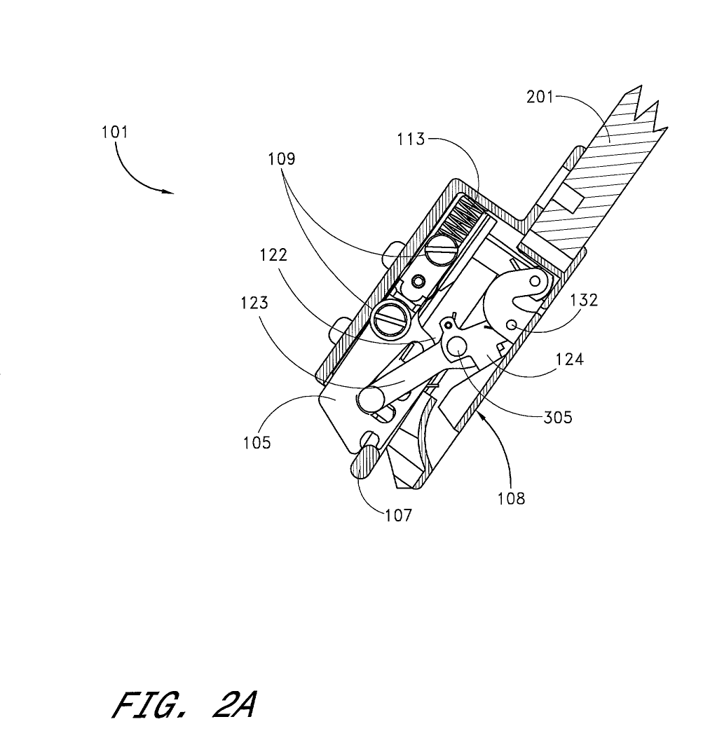

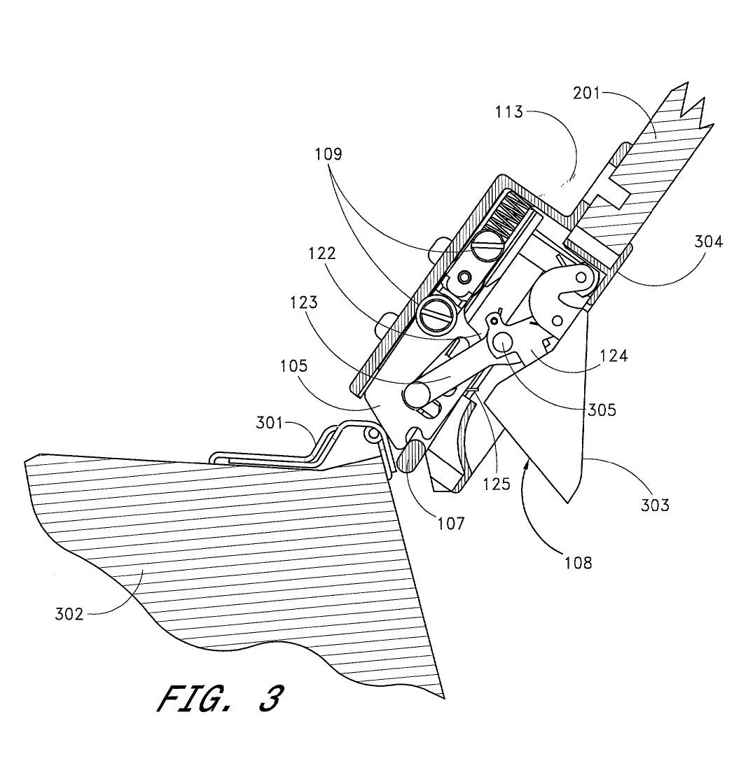

The handle 108 is rotatably fixed to the back portion of the housing 103. The handle 108 has four arms 119. The back portion of the housing 103 has two members 118 that are perpendicular to and extend from the back portion of the housing. Each member 118 is sized to fit between two of the arms 119. The handle 108 is connected to the back portion of the housing 103 by inserting the pin 121 through holes in the arms 119, members 118, and through the spring 120. The handle 108 is biased by the spring 120 toward a flush position with the face of the housing, as seen in FIG. 2A, but is able to rotate about the handle pin 121 and away from the housing, as seen in FIG. 3.

As shown in more detail in FIG. 1B, the pawl 105 is connected to the handle 108 by a free-travel link 122 comprised of two arms 123, 124 that are connected on one end by a pin 128 and may rotate about the pin. Disposed between the connection and on pin 128 is a torsion spring 129. Spring 129 holds the two arms 123 and 124 in an orientation causing a connection pin 127, that connects arm 123 with the pawl 105, to rest along the smooth surface of a slot 133 in the pawl 105 and away from the notches 126, in the slot, when the handle is in a flush position with the housing. This orientation provides a connection between the pawl and arm 123 that allows the pawl to freely extend from the housing without interference from the link 122.

The other arm 124 is connected to the handle 108 by a pin 132 and a plurality of e-rings 130. Disposed between the connection along the pin 132 is a spring 131 that is connected to arm 123. The spring 131 works with spring 129 causing the arms 123, 124 to be biased toward maintaining a specific orientation and away from rotating about pin 128. If the arms are forced to rotate about pin 128, the springs 129, 131 provide a sufficient force to urge the arms to recoil back to the specific orientation once the force, which caused the arms to rotate, is removed.

The arms 123, 124 are connected to the pawl 105 and the handle 108, respectively, such that when the handle 108 is lifted, the free-travel link 122 catches onto one of the notches 126 and draws the pawl 105 into the housing.

As seen in FIG. 2, the components of the preferred embodiment are connected, without the back portion of the housing 103, with the pawl 105 being held in its catched position by catch 107.

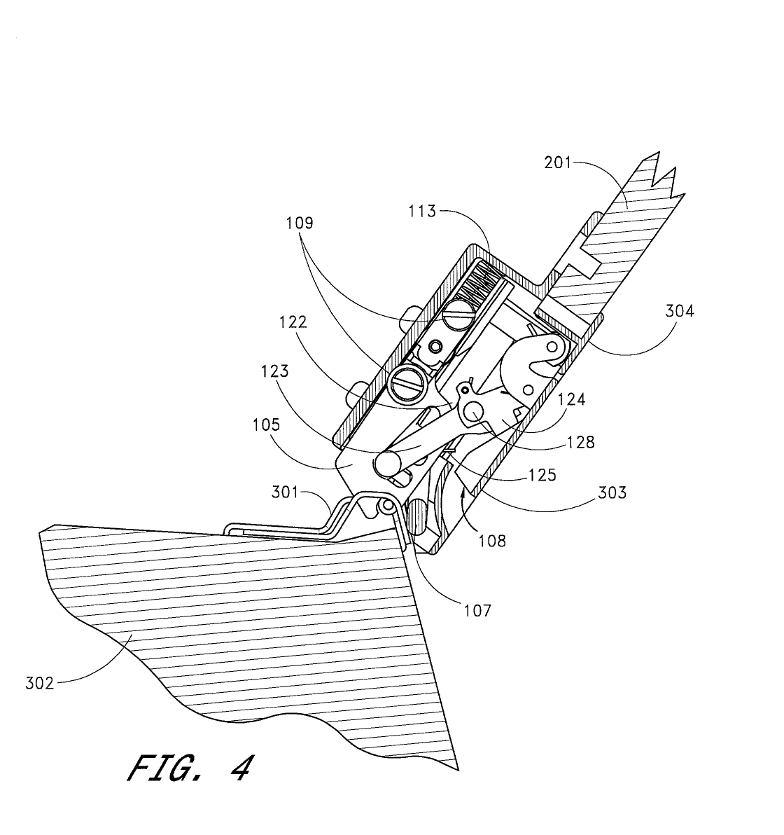

When the compartment door 201 is swung toward an overhead storage bin 302, as shown in FIG. 3, the pawl 105 comes in contact with a strike 301 on the bottom wall of the bin 302 causing the pawl to retract into the housing of the latch 101 and away from the catch 107. The rollers 109 assist the pawl as it slides into the housing. As the pawl retracts into the housing, however, the springs 113 are further compressed. The catch is then forced from its engagement with the pawl when the strike 301 hits the catch. The catch is urged by the strike to rotate away from the pawl so that the strike may engage with the pawl as seen in FIG. 4.

The front face of the handle 303 is normally flush with the front of the latch 304 as seen in FIG. 2A. However, when the strike 301 hits the pawl 105, forcing the pawl 105 into the housing, the free-travel link 122 forces the handle 108 to rotate away from the housing, as seen in FIG. 3, such that the top portion of the handle 303 is no longer flush with the front face of the housing 304. As the pawl 105 engages with the strike 301 to a latched position, as seen in FIG. 4, the springs 113 recoil and the handle 108 rotates to where the top portion of the latch handle 303 is again flush with the front face of the latch housing 304.

If the pawl 105 and strike 301 are not fully engaged, as shown in FIG. 3, the front face of the handle 303 will have a tendency to be in an unflush position with the front face of the latch housing 304. The position of the front face of the handle 303 provides a signal as to whether the compartment door 201 is completely closed and connected with the compartment bin 302.

The two arms 123, 124 of the free-travel link 122 are capable of rotating about its connection pin 128 to allow the pawl 103 to come into contact and engage with the strike 301 without requiring the latch handle 108 to rotate. Thus, the front face of the latch handle 303 is able to maintain its flush position with the front face of the latch 304 when the pawl 103 comes in contact with the strike 301. The two arms 123, 124 of the free-travel link 122 advantageously allow the compartment door 201 to fully close and to engage with the compartment bin 302 even if there is an obstruction, such as a person's hand, which prevents the handle 108 from rotating away from the latch housing.

The pawl 105 may be disengaged from the strike 301 by lifting the handle 108 up and rotating it about pin 121 so that the face of the handle 303 is in an unflush position. When the handle is lifted, the arm 123 catches one of the notches 126, along the pawl slot 133, causing the pawl to disengage with the strike 301 while drawing the pawl into the housing. As the handle is lifted and the pawl is drawn into the housing, the catch 107 will be urged by spring 125 to engage with the pawl so that the pawl will be in a catched position as seen in FIGS. 2 and 2A.

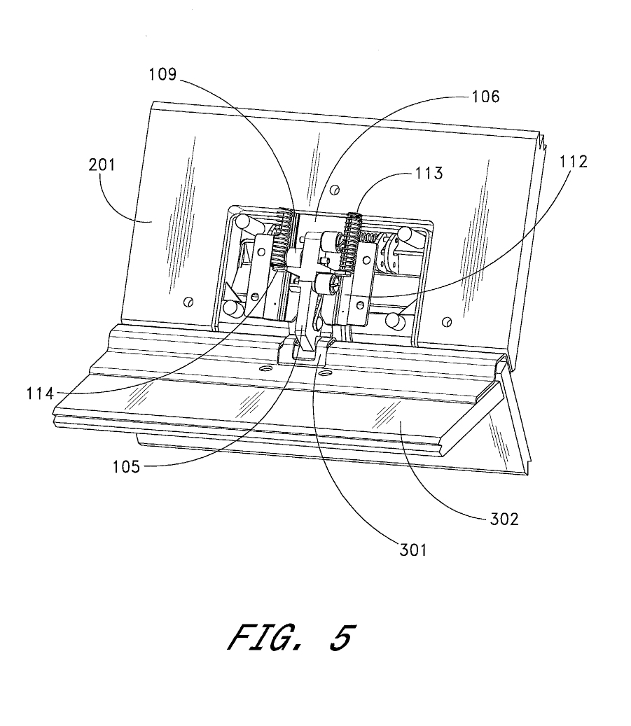

FIG. 5 is an isometric view of the preferred embodiment without the back portion of the housing 103 showing the storage bin 302 in an undeflected normal position. The pawl 105 is shown in positive engagement with the strike 301. The rollers 109 of the pawl 105 are shown in contact with the track formed between the two grooves 112 on the track cover 106. The compression springs 113 are shown partially contained within the grooves 112 of the track cover 106.

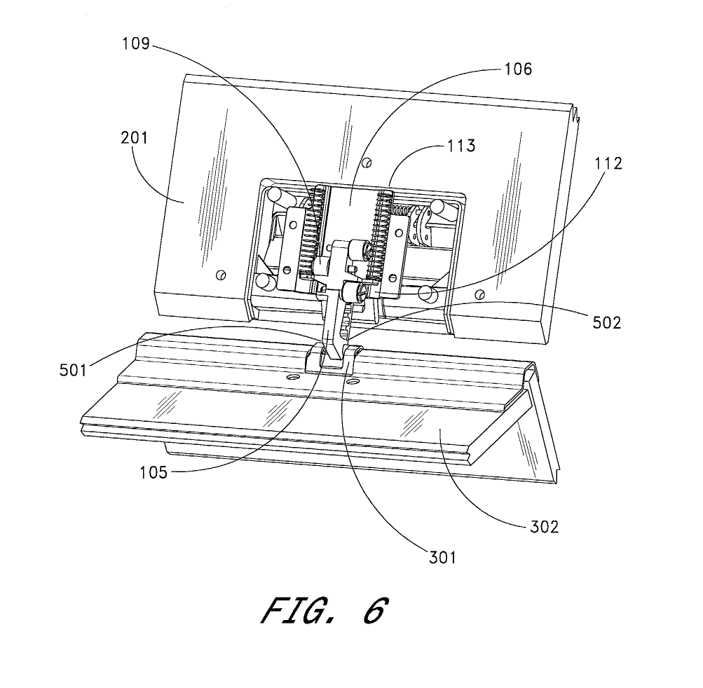

When the storage bin 302 deflects, as shown in FIG. 6, the pawl 105, aided by the compression springs 113, extend to maintain positive engagement with the strike 301. The rollers 109 and the compression springs 113 work to reduce and provide additional force to overcome the friction force that the pawl 105 encounters along the length of the tract between the grooves 112.

Although the preferred embodiment has a pawl 105 with an angled end 501 having a notch 502 for assisting and providing positive engagement with the strike 301, the notch 502 is not necessary for the pawl 105 to follow the movements of a deflecting bin 302. The compression springs 113 of the preferred embodiment provide sufficient force to allow the pawl 105 to extend from the latch housing to maintain positive engagement with the strike 301 of a deflecting bin 302.

Additionally, while the preferred embodiment has rollers 109 connected to the pawl 105, the rollers 109 are not necessary for the latch 101 to operate. The rollers 109 merely assist the pawl 105 to maintain engagement with the strike by reducing friction along the pawl's 105 travel path. The rollers 109 could be left out or could be easily replaced with a friction reducing strip or grease.

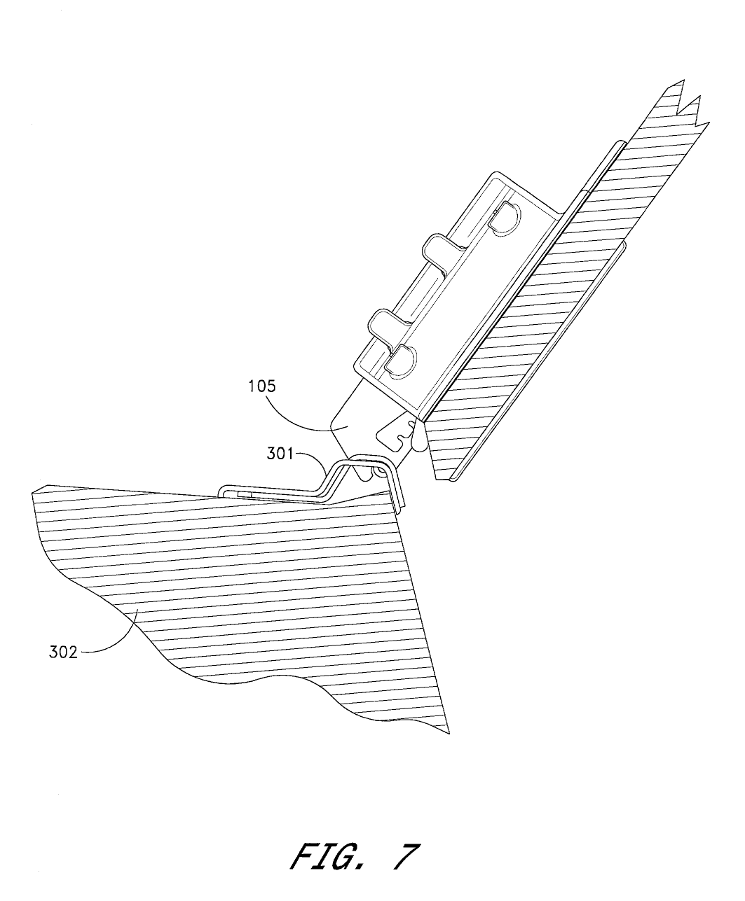

FIG. 7 is a side profile view of the preferred embodiment in positive engagement with the strike 301 of a deflecting bin 302. The pawl 105 is shown extended from its normal position and away from the latch housing with the latch handle 108 flush with the face of the latch housing. Even when the bin 302 is in a deflected position, the door latch 101 may be disengaged from the strike 301 on the bin. The pawl 105 may be disengaged from the strike by lifting the handle 108 up and rotating it about pin 121. The link arm 123 will catch one of the notches 126 drawing the pawl into the housing and causing the pawl to disengage with the strike.

Although the foregoing invention has been described in terms of certain preferred embodiments, other embodiments will become apparent to those of ordinary skill in the art, in view of the disclosure herein. Accordingly, the present invention is not intended to be limited by the recitation of preferred embodiments, but is instead to be defined solely by reference to the appended claims.

What is claimed is:

1. A latch mechanism for a door that engages with an overhead storage bin of an aircraft, said mechanism comprising:
a housing to be positioned on said door; and
a pawl in said housing mounted to cooperate with a strike secured to the bin to hold the door closed, said pawl being mounted in a manner capable of extending from the housing in response to a biasing force so as to continue to hold the door closed if the bin deflects away from the door in response to a deflecting force.

2. The mechanism of claim 1, including a biasing element urging said pawl away from the housing.

3. The mechanism of claim 2, wherein the biasing element is a compression spring.

4. The mechanism of claim 2, including a catch preventing extension of said pawl when said door is open and the pawl is not engaging the strike.

5. The mechanism of claim 4, wherein said catch is biased into position to prevent extension of the pawl, and the catch is movable by said strike when the door is closed so as to release the pawl and allow it to follow the movement of the bin if it deflects away from the door.

6. The mechanism of claim 1, including a handle linked to said pawl so as to retract the pawl and permit the door to be opened.

7. The mechanism of claim 1, wherein said pawl includes a slot having a plurality of positions in which it may be linked to a handle that is capable of retracting the pawl to permit the door to be opened, in any position of the bin.

8. The mechanism of claim 7, including a free-travel link that connects the handle to the pawl, wherein the free-travel link is comprised of two arms that are rotatably connected at a pivot point but biased by a torsion spring toward maintaining a fixed position such that the two arms may function as an inflexible unitary element.

9. The mechanism of claim 8, wherein the handle is connected to the housing in a manner that allows the handle to rotate about a fixed point.

10. The mechanism of claim 1, including a catch preventing extension of said pawl in response to said biasing force when said door is open and the pawl is not engaging the strike.

11. The mechanism of claim 10, wherein said catch is configured to release said pawl as a result of engaging the strike as the door is closed.

12. The mechanism of claim 1, including a friction reducing element minimizing traction between the pawl and the housing if the pawl retracts into the housing or extends away from the housing.

13. The mechanism of claim 12, wherein the friction reducing element is attached to the pawl and disposed between the pawl and the housing.

14. The mechanism of claim 12, wherein the friction reducing element is at least one roller.

15. A latch mechanism for maintaining a door engaged with a compartment so as to keep the door in a closed position, said mechanism including:
a housing to be mounted in said door;
a pawl in said housing having a retracted position in which a portion of the pawl engages a strike secured to the compartment to hold the door in the closed position, said pawl being extendable from the retracted position away from the housing towards the compartment;
a biasing element in said housing urging said pawl to extend away from the housing;
a catch for restricting extending movement of the pawl, said catch being positioned to be moved by said strike to release said pawl when the door is closed thereby causing the pawl to extend in response to the urging of said biasing element if said compartment deflects away from the door and causing the pawl to remain engaged with said strike so that the door remains in a closed position; and
a handle mounted to said housing and linked to said pawl so that moving the handle to open the door retracts the pawl from the strike, permitting the door to be opened.

16. A method of maintaining closed a door of a storage bin if a bottom wall of the bin deflects downwardly, said method comprising the steps of:
providing for installation in said door a latch mechanism which includes a pawl that engages a strike attached to the bottom wall to hold the door closed; and
urging the pawl to extend downwardly to continue to engage the strike and hold the door closed when the wall deflects downwardly in response to a deflecting force.

17. The method of claim 16, including the step of restraining the extending movement of said pawl when said door is opened.

18. The method of claim 17, using a catch to restrain the pawl, and including the step of moving the catch to release the pawl in response to the catch engaging the strike as the door is closed.

19. The method of claim 18 including the step of biasing said catch into position to restrain the pawl as the pawl is moved away from the strike during opening movement of the door.

20. An assembly comprising:
an aircraft overhead storage bin having a bottom wall and a front door which is swingable upwardly to provide access to the storage bin and swingable downwardly to close the bin; and
a latch mechanism for latching the door to the bottom wall in a closed position, said mechanism including a latching member mounted to the door and a strike attached to the bin bottom wall, said latching member being configured to cooperate with the strike to latch the door in a closed position, and said latching member being biased downwardly so that it will continue to cooperate with said latch to maintain the door closed if the bottom wall of the bin deflects downwardly in response to a deflecting force.
